(19) United States
(12) Patent Application Publication
(10) Pub. No.: US 2026/0288283 A1
(43) Pub. Date: Sep. 24, 2026

(54) IMAGE INTERACTION SYSTEM AND IMAGE INTERACTION METHOD

(71) Applicant: COMPAL ELECTRONICS, INC., Taipei City (TW)

(72) Inventors: Yi-Han Liao, Taipei City (TW); Kun-Hsuan Chang, Taipei City (TW)

(73) Assignee: COMPAL ELECTRONICS, INC., Taipei City (TW)

(21) Appl. No.: 19/568,735

(22) Filed: Mar. 16, 2026

Related U.S. Application Data
(60) Provisional application No. 63/776,250, filed on Mar. 23, 2025.

(51) Int. Cl. G06F 3/042; G06T 3/40

(52) U.S. Cl. CPC G06F 3/0425; G06T 3/40

(57) ABSTRACT

An image interaction system and an image interaction method are provided. The system includes a projector, a depth sensor, and a processor. The projector projects an image onto a projection surface. The depth sensor detects depth information of the projection surface. The processor changes an image content of the image according to a variation of the depth information.

### CROSS-REFERENCE TO RELATED APPLICATION

This application claims the priority benefit of U.S. provisional application serial no. 63/776,250, filed on March 23, 2025. The entirety of the above-mentioned patent application is hereby incorporated by reference herein and made a part of this specification.

### BACKGROUND

### Technical Field

The disclosure relates to a human-computer interaction technology, and in particular relates to an image interaction system and an image interaction method.

### Description of Related Art

With the advancement of projection technologies and human-computer interaction technologies, immersive projection systems have been widely deployed in the fields of education, entertainment, and smart‑home environments. Existing interactive projection technologies predominantly employ depth cameras or image capture devices to detect gestures of users and, on that basis, to operate upon a fixed projected image.

It is noteworthy that existing human-computer interaction technologies, whether employing touch screens, optical detection, or depth cameras for gesture control, are generally deficient in automatic adaptability to environmental variations or operating distance. In particular, in projection‑based interactive systems, when the distance (i.e., the depth or projection height) between the projection device and the projection surface changes, existing systems do not provide an automatic image content switching mechanism, thereby further impairing the smoothness and continuity of the interactive process.

### SUMMARY

An image interaction system and an image interaction method are provided in the disclosure, in which the projected image content and corresponding operation mode may be dynamically change according to the variation of depth information between the projection device and the projection surface, thereby enhancing the interactive intuitiveness.

An image interaction system of this disclosure includes (but is not limited to) a projector, a depth sensor, and a processor. The projector projects an image onto a projection surface. The depth sensor detects depth information of the projection surface. The processor is coupled to the projector and the depth sensor, and is configured to change an image content of the image according to a variation of the depth information.

The image interaction method of this disclosure includes (but is not limited to) the following operation. An image is projected onto a projection surface through a projector. Depth information corresponding to the projection surface is detected through a depth sensor. An image content of the image is changed according to a variation of the depth information through the processor.

Based on the above, the image interaction system and the image interaction method of the disclosure establish a dynamic coupling relationship between the projection distance and the hierarchical levels of the image content from a macroscopic level to a microscopic level. When the projection distance changes, the system may present is not only capable of presenting hierarchically structured image content that is logically associated. Therefore, the embodiments of the disclosure may provide a smoother, more intuitive and user-friendly immersive interactive experience, thereby significantly improving the efficiency and stability of human-computer interaction.

In order to make the above-mentioned features and advantages of the disclosure comprehensible, embodiments accompanied with drawings are described in detail below.

### BRIEF DESCRIPTION OF THE DRAWINGS

FIG. 1 is a component block diagram of an image interaction system according to an embodiment of the disclosure.

FIG. 2 is a schematic diagram of the usage scenario of an image interaction system according to an embodiment of the disclosure.

FIG. 3 is a flowchart of an image interaction method according to an embodiment of the disclosure.

FIG. 4 is a flowchart of a method for changing the image content according to an embodiment of the disclosure.

FIG. 5 is a schematic diagram illustrating the variation of the image content and the operation mode across depth intervals according to an embodiment of the disclosure.

FIG. 6 is a flowchart of a method for obtaining multimedia data according to the depth interval according to an embodiment of the disclosure.

FIGS. 7A and FIG. 7B are schematic diagrams illustrating the node parameters and hierarchical relationships in an Earth navigation scenario according to an embodiment of the disclosure.

FIG. 8 is a flowchart illustrating a user operation detection method according to an embodiment of the disclosure.

FIG. 9 is a flowchart illustrating a method for determining execution permission according to the depth interval according to an embodiment of the disclosure.

FIGS. 10A and FIG. 10B are schematic diagrams of node parameters and hierarchical relationships in a smart home application scenario according to another embodiment of the disclosure.

### DETAILED DESCRIPTION OF DISCLOSED EMBODIMENTS

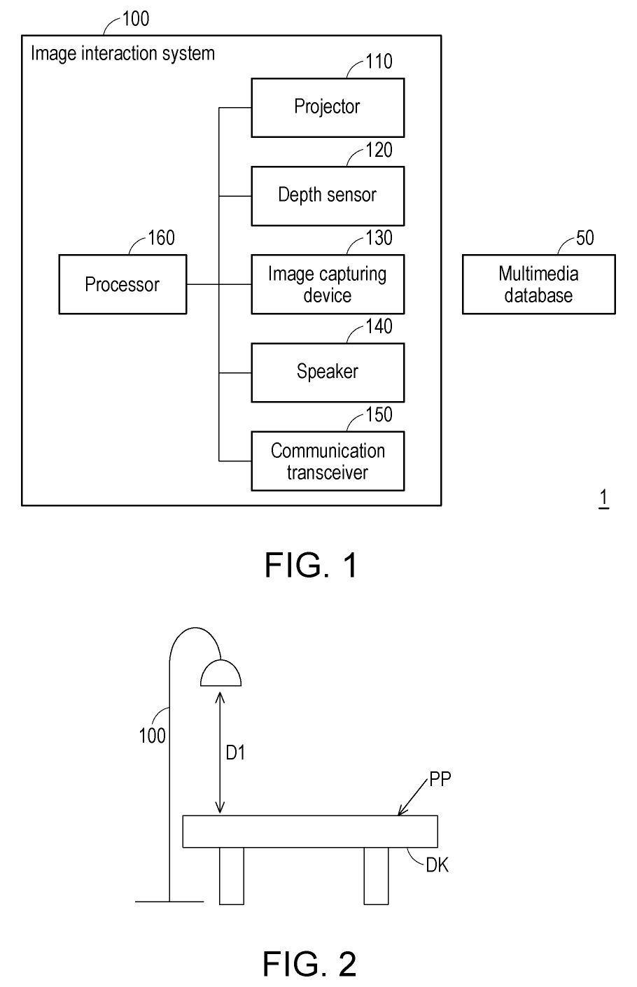

FIG. 1 is a component block diagram of an image interaction system 100 according to an embodiment of the disclosure. Referring to FIG. 1, the image interaction system 100 may be a computing host integrated into a desk lamp, a suspended projection device, or other position-adjustable electronic device. The image interaction system 100 includes (but is not limited to) a projector 110, a depth sensor 120, an image capturing device 130, a speaker 140, a communication transceiver 150, and a processor 160.

The projector 110 is, for example, an LCD projector, a DLP projector, or a laser projector. In one embodiment, the projector 110 is configured to receive image signals output by the processor 160 and project an image onto a projection surface (e.g., a wall, projection screen, whiteboard, or other surface).

The depth sensor 120 may be a structured light, time-of-flight (ToF), stereo vision, or a laser scanning device. In one embodiment, the depth sensor 120 is configured to detect the distance or depth value between its representative position, or that of the image interaction system 100, and the projection surface, and to generate corresponding depth information.

The image capturing device 130 may be a complementary metal-oxide-semiconductor (CMOS) or charge-coupled device (CCD) camera. In one embodiment, the image capturing device 130 is configured to capture images of a region in which the projection surface is located. In some application scenarios, the image capturing device 130 is configured to capture images of user operation or movements in front of a projector. In one embodiment, the depth sensor 120 may be integrated with the image capturing device 130 into a single module, such as an RGB-D camera.

In one embodiment, the speaker 140 is configured to receive audio signals output by the processor 160 and play corresponding sounds to provide auditory feedback in conjunction with the image content.

The communication transceiver 150 is, for example, a wireless communication transceiver circuit such as Wi-Fi, mobile communication, Bluetooth, or Zigbee. In one embodiment, the communication transceiver 150 is configured to enable the image interaction system 100 to exchange data with external devices (e.g., smart home appliance) or a network.

The processor 160 is coupled to the projector 110, the depth sensor 120, the image capturing device 130, the speaker 140, and the communication transceiver 150. The processor 160 may be a central processing unit (CPU), a graphics processing unit (GPU), an application-specific integrated circuit (ASIC), or a combination thereof. In one embodiment, the processor 160 is configured to execute the image interaction method described in the embodiments of the disclosure, and may load and execute various code, software modules and/or data stored in the memory (not shown).

In one embodiment, the image interaction system 100 further includes a multimedia database 50. The multimedia database 50 may be built into the memory of the image interaction system 100, may be implemented as an external storage device, or may reside on a cloud server. In one embodiment, the multimedia database 50 is configured to store multimedia data related to the image content, such as images, videos, audio files, and corresponding node parameters. The processor 160 may read the required multimedia data from the multimedia database 50.

FIG. 2 is a schematic diagram of the usage scenario of an image interaction system 100 according to an embodiment of the disclosure. Referring to FIG. 2, the image interaction system 100 (taking a desk lamp device as an example) is disposed above a desk DK. The desktop of the desk DK serves as a projection surface PP. The depth sensor 120 may detect the vertical distance between the representative position (e.g., the lamp body) of the image interaction system 100 and the projection surface PP. This distance is the depth value D1, which corresponds to the depth information. Users may manually or electrically adjust the height of the projector 110 of the image interaction system 100, thereby changing the depth value D1.

In order to facilitate understanding of the operation process of the embodiments of the disclosure, the operation process of the embodiments of the disclosure will be described in detail with reference to a number of embodiments below, and the methods described in the embodiments of the disclosure will be explained in conjunction with the various elements or devices in FIGS. 1 and FIG. 2.

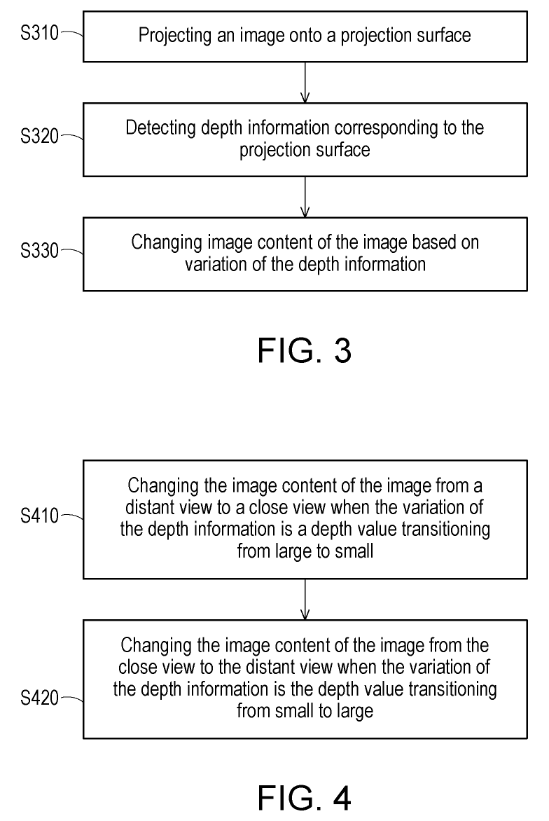

FIG. 3 is a flowchart of an image interaction method according to an embodiment of the disclosure. Referring to FIG. 3, the processor 160 controls the projector 110 to project an image onto the projection surface PP (step S310). Specifically, in an initial state, the processor 160 may preset an initial image, such as a main menu screen or a wide-area overview image.

The processor 160 continuously detects the depth information corresponding to the projection surface PP through the depth sensor 120 (step S320). Specifically, the depth information defines the spatial distance between the image interaction system 100 and the projection surface PP. This distance may be quantified as a depth value. In one embodiment, the processor 160 performs an initial plane correction when the system starts up, defines the projection surface PP with no objects placed on it as the reference height zero, and calculates subsequent depth values based on this reference.

The processor 160 changes the image content of the image according to a variation of the depth information (step S330). Specifically, "a variation of the depth information" refers to the depth value undergoing a change sufficient to cross a preset (depth) interval. When the user adjusts the position of the projector 110, causing a change in the depth value, the processor 160 will detect this variation, select new multimedia data from the multimedia database 50, and then control the projector 110 to project the image of the new multimedia data. In this way, the projected content will change dynamically depending on the position of the projector 110.

FIG. 4 is a flowchart of a method for changing the image content according to an embodiment of the disclosure. Referring to FIG. 4, when the processor 160 determines that the variation of the depth information is the depth value transitioning from large to small, the processor 160 changes the image content of the image from a distant view content to a close view content (step S410). Specifically, "distant view content" refers to images that are more broad and general, while "close view content" refers to images that are more microscopic and specific in detail. Taking FIG. 2 as an example, when the user lowers the interactive image system 100 to bring it closer to the projection surface PP, the projected image will be scaled down from the whole view of the Earth (distant view content) to the scene of the African continent (close view content).

Conversely, when the processor 160 determines that the variation of the depth information is the depth value transitioning from small to large, the processor 160 changes the image content of the image from a close view content to a distant view content (step S420). Taking FIG. 2 as an example, when the user raises the interactive image system 100 away from the projection surface PP, the projected image reverts from the scene of the African continent (close view content) to the whole view of the Earth (distant view content).

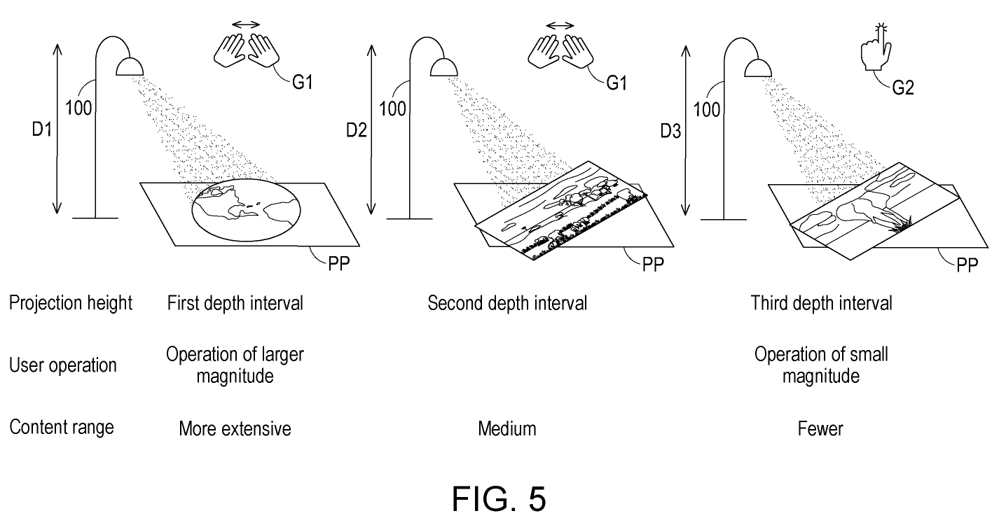

FIG. 5 is a schematic diagram illustrating the variation of the image content and the operation mode across depth intervals according to an embodiment of the disclosure. Referring to FIG. 5, in order to achieve content switching, the processor 160 may map the detected depth value to multiple pre-divided depth intervals. In one embodiment, the close view content and the distant view content are in a hierarchical scaling relationship. The multiple depth intervals may include a first depth interval corresponding to a larger projection depth, a second depth interval corresponding to a medium projection depth, and a third depth interval corresponding to a smaller projection depth. Each depth interval is defined by upper and lower limits of its depth values. In other words, each depth interval is a range of depth values between a specific upper and lower limit.

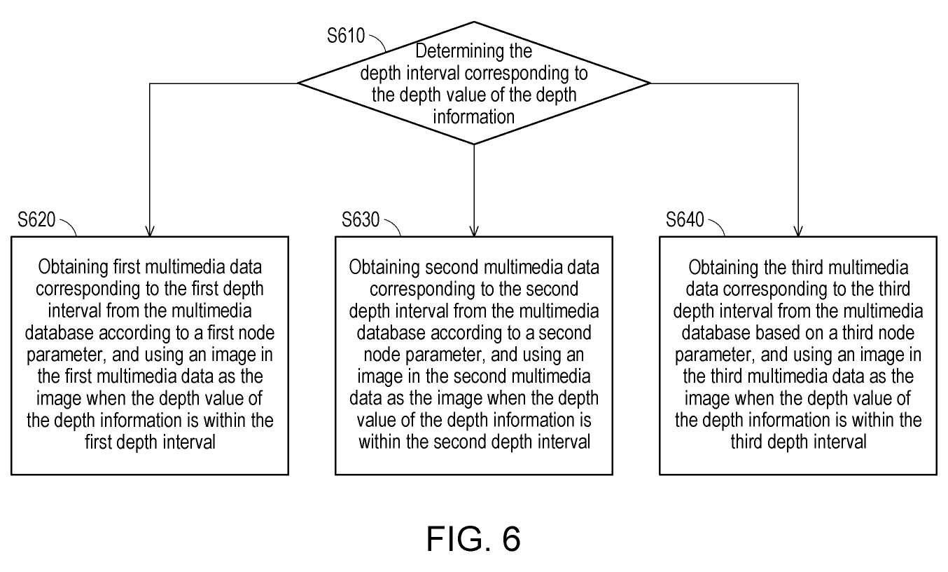

FIG. 6 is a flowchart of a method for obtaining multimedia data according to the depth interval according to an embodiment of the disclosure. Referring to FIG. 6, the processor 160 may determine the depth interval corresponding to the currently detected depth value (step S610). In other words, the processor 160 determines the depth interval (i.e., the corresponding range of depth values) within which the depth value lies.

When the depth value of the depth information is within the first depth interval, the processor 160 may obtain the first multimedia data corresponding to the first depth interval from the multimedia database 50 according to a first node parameter, and use the image in the first multimedia data as the image for projection by the projector 110 (step S620). Taking FIG. 5 as an example, when the projection depth (e.g., depth value D1) is in the first depth interval (e.g., 50 to 70 cm or 45 to 65 cm), the corresponding content range is the widest (more extensive), and the image interaction system 100 will display a distant view content.

When the depth value of the depth information is within the second depth interval, the processor 160 may obtain the second multimedia data corresponding to the second depth interval from the multimedia database 50 according to a second node parameter, and use the image in the second multimedia data as the image for projection by the projector 110 (step S630). Taking FIG. 5 as an example, when the projection depth (e.g., depth value D2) is in the second depth interval (e.g., 30 to 50 cm or 25 to 45 cm), the corresponding content range is smaller (medium) than that in the first depth interval, and the image interaction system 100 will display a close view content relative to the first multimedia data. In other words, the image of the first multimedia data is a distant view content relative to the second multimedia data.

When the depth value of the depth information is within the third depth interval, the processor 160 may obtain the third multimedia data corresponding to the third depth interval from the multimedia database 50 according to a third node parameter, and use the image in the third multimedia data as the image for projection by the projector 110 (step S640). Taking FIG. 5 as an example, when the projection depth (e.g., depth value D3) is in the third depth interval (e.g., 10 to 30 cm), the corresponding content range is smaller (fewer) than that in the second depth interval, and the image interaction system 100 will display a close view content relative to the second multimedia data. In other words, the images of the first and second multimedia data are distance view contents relative to the third multimedia data.

The aforementioned first, second, and third node parameters are configured to define the hierarchy and relationship between corresponding multimedia data to ensure that the switching of image content has logical coherence. The second node parameter is hierarchically lower than the first node parameter, and the second node parameter includes a portion of the content of the first node parameter. The third node parameter is hierarchically lower than the second node parameter, and the third node parameter includes a portion of the content of the second node parameter.

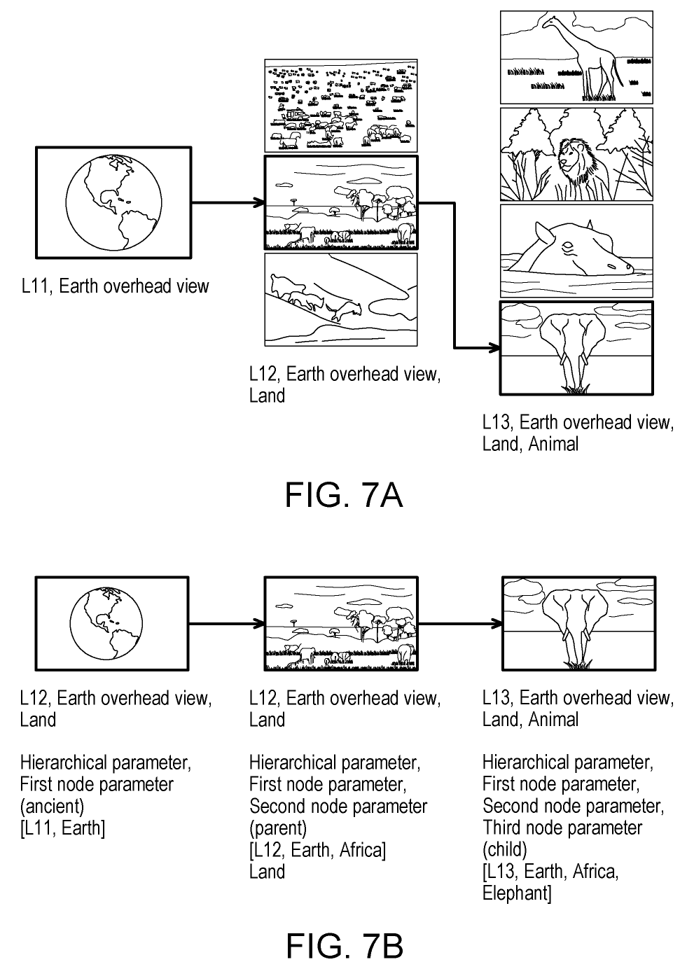

For example, FIGS. 7A and FIG. 7B are schematic diagrams illustrating the node parameters and hierarchical relationships in an Earth navigation scenario according to an embodiment of the disclosure. Referring to FIGS. 7A and FIG. 7B, which illustrate a scenario in which embodiments of the present disclosure may be applied for educational exploration or ecological learning. In this scenario, the image content of the first multimedia data is an Earth overhead view (L11), the image content of the second multimedia data is a scene of a specific continent (e.g., an African continent image L12), and the image content of the third multimedia data is a specific animal on that continent (e.g., an elephant image L13).

As shown in FIG. 7B, the processor 160 manages these image contents through node parameters with hierarchical relationships. The first node parameter may be defined as [L11, Earth], which serves as the ancient node at highest level within the hierarchy. The second node parameter may be defined as [L12, Earth, Africa], which serves as the parent node of the next layer and includes the content of the first node parameter (Earth). The third node parameter may be defined as [L13, Earth, Africa, Elephant], which serves as the child node at the lowest level within the hierarchy and includes the contents of the second node parameter (Earth, Africa). With this structure, the processor 160 may provide a parent-child related image zooming experience between different depth intervals, allowing viewers to explore from the broad view of Earth layer by layer to the microscopic animal details.

It should be noted that the above embodiment uses three depth intervals as an example, but the number of depth intervals and the corresponding depth value range may still be changed according to actual requirements.

Referring to FIG. 5, different depth intervals may also correspond to different user operation modes. For example, operations of larger magnitude are allowed in the first and second depth intervals, while operations are switched to a smaller magnitude in the third depth interval. The foregoing will be described in further detail hereinafter.

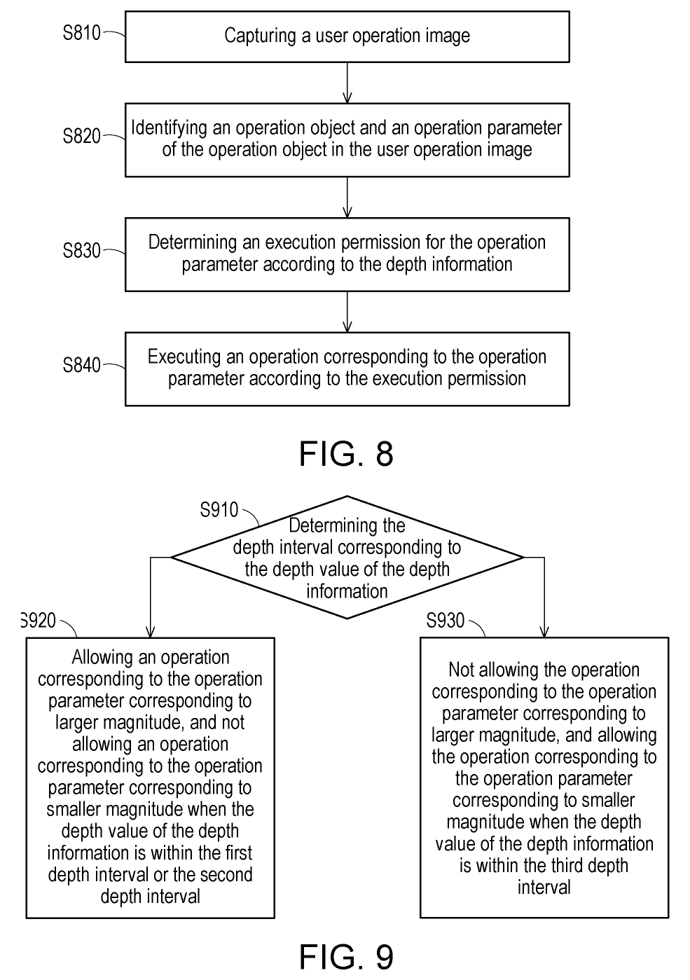

FIG. 8 is a flowchart illustrating a user operation detection method according to an embodiment of the disclosure. In addition to changing the image content according to depth information, the image interaction system 100 of the disclosure may also detect the gesture operation of the user. Referring to FIG. 8, the processor 160 may capture a user operation image through the image capturing device 130 (step S810). Taking FIG. 2 as an example, the user operation image captures the movements of the hands of the user or other operation objects on the projection surface PP.

The processor 160 may identify an operation object and an operation parameter of the operation object in the user operation image (step S820). Specifically, the operation object is, for example, the palm or fingers of the user. The operation parameter is a parameter obtained by quantifying or classifying the actions of the operation object. In one embodiment, the processor 160 may have one or more built-in artificial intelligence hand recognition modules or send user operation images to a cloud server via the communication transceiver 150 to analyze the user operation images and generate joint node information of the hand object. This joint node information may be used to interpret specific operation parameters, for example, gestures such as drag, wave, click, or touch. In another embodiment, the processor 160 may identify the operation parameters of the operation object by comparing with the image features of a reference gesture.

The processor 160 may determine the execution permission of the current operation parameter according to the depth information previously detected by the depth sensor 120 (step S830). Specifically, execution permission defines whether the image interaction system 100 is allowed to execute a certain gesture operation at a specific depth value or depth interval.

The processor 160 may execute the operation corresponding to the operation parameter according to the determined execution permission (step S840). The execution permission determines whether the operation corresponding to the operation parameter is allowed. In other words, if the current gesture operation is allowed, the processor 160 may execute the corresponding function (e.g., rotating the Earth image, switching scenes, or interacting with objects, but not limited thereto). If it is not allowed, the processor 160 will ignore this gesture operation.

FIG. 9 is a flowchart illustrating a method for determining execution permission according to the depth interval according to an embodiment of the disclosure, which is a detailed description of step S830 in FIG. 8. Referring to FIG. 9, the processor 160 may determine the depth interval corresponding to the depth value of the current depth information (step S910). In other words, the processor 160 determines the depth interval (i.e., the corresponding range of depth values) within which the depth value lies.

When the depth value of the depth information is within the first depth interval or the second depth interval, the processor 160 may allow the operation corresponding to the operation parameter corresponding to larger magnitude, and prohibit/not allow the operation corresponding to the operation parameter corresponding to smaller magnitude (step S920). Here, "operation of larger magnitude" refers to a gesture with a relatively broad range of motion that does not require high precision, for example, the aforementioned drag gesture or the wave gesture G1 shown in FIG. 5. "Operation of smaller magnitude" refers to a gesture with a concentrated range of motion that requires high precision, for example, the click gesture G2 or touch gesture shown in FIG. 5. In other words, when the projection depth is greater and the image is presented at a broader scale, users may interact using large gestures; conversely, they may interact using small gestures.

Conversely, when the depth value of the depth information is within the third depth interval, the processor 160 may prohibit/not allow the operation corresponding to the operation parameter corresponding to larger magnitude, and allow the operation corresponding to the operation parameter corresponding to smaller magnitude (step S930). In other words, when the projection depth is reduced and the image is presented at a more microscopic scale and becomes detailed, the image interaction system 100 switches the operation mode, thereby facilitating the execution of precise interactions by users. In this way, the precision of the operation may be matched with the detail of the image content.

Taking FIGS. 7A and FIG. 7B as examples, in one application scenario, when the user stands in front of the projection surface PP and the projector 110 is 70 cm away from the projection surface PP, the image interaction system 100 displays a panoramic view of the Earth and allows users to rotate the Earth image to select different continents or oceans and other broad view scenes. For example, users may operate the Earth image through a drag gesture, thereby orienting the Africa image toward the user.

The user lowers the projector 110 to a distance of 50 centimeters from the projection surface PP. At this point, the interactive image system zooms in on the Earth image to display the African scene, allowing users to switch among forested regions with a wave gesture. For example, the user may, through a wave gesture, operate the image to switch among image scenes such as the African savanna, a national park, a forest, and the like, and may remain on the forest image scene.

When the user lowers the projector 110 to a distance of 20 centimeters from the projection surface PP, the image interaction system 100 enters touch mode and displays a specific microscopic scene (such as an elephant). The user may interact with the elephant image by clicking, and learn about educational content such as elephant vocalizations, behavioral characteristics, and anatomical structure, etc.

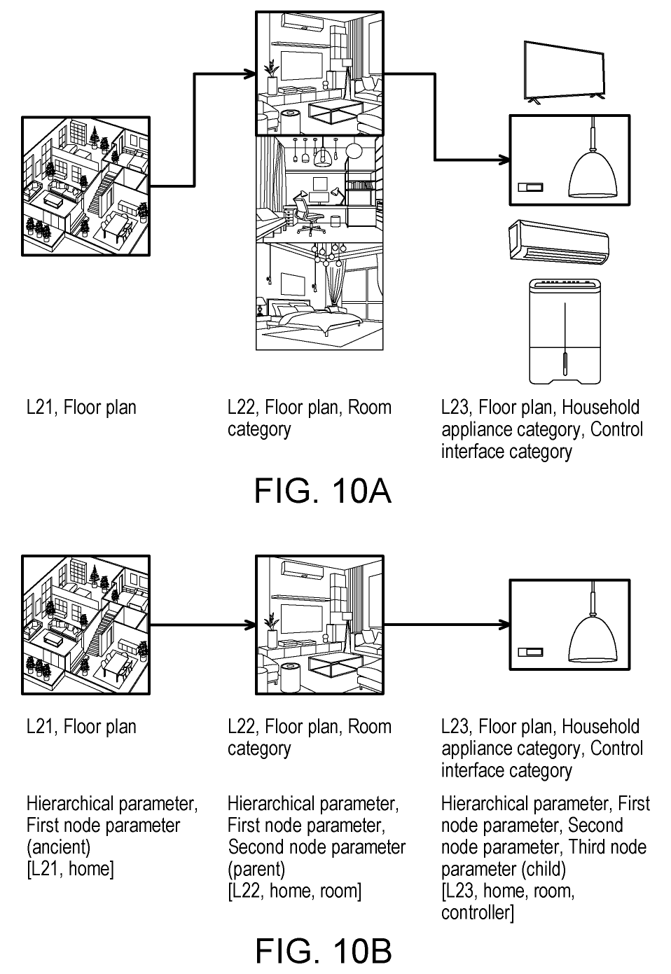

FIGS. 10A and FIG. 10B are schematic diagrams of node parameters and hierarchical relationships in a smart home application scenario according to another embodiment of the disclosure. Referring to FIGS. 10A and FIG. 10B, the embodiments of the disclosure may also be applied to the field of smart home control. In this scenario, the image content also follows a hierarchical relationship. For example, the image content of the first multimedia data is a floor plan L21 of the entire home environment. The image content of the second multimedia data is an interior view of a specific room (e.g., a room category image L22 such as a living room or bedroom). The image content of the third multimedia data is household appliance and its control interface category image L23 in a specific room.

As shown in FIG. 10B, the node parameters in this application scenario also have a hierarchical relationship. The first node parameter may be defined as [L21, home]. The second node parameter may be defined as [L22, home, room], which is at a lower level than the first node parameter and includes the content of the first node parameter (L21, home). The third node parameter may be defined as [L23, home, room, controller], which is at a lower level within the hierarchy than the second node parameter and includes the content of the second node parameter (L23, home, room).

In one application scenario, when a user stands in front of the projection plane PP and the projector 110 is 70 cm away from the projection plane PP, the image interaction system 100 displays a panoramic view of the entire home environment (e.g., each room and appliance), and the user may select different rooms through a drag gesture to view the current status of the appliance (e.g., lights, air conditioning, sound system, etc.). For example, users may operate the panoramic image through a drag gesture to display the living room.

The user lowers the projector 110 to a distance of 50 centimeters from the projection surface OO. At this time, the image interaction system 100 automatically zooms in to display the appliance in the selected room, such as the lighting, temperature, and electrical appliance status of the room. For example, users may adjust the brightness of lights or switch room appliances through a wave gesture.

When the user lowers the projector 110 to a distance of 20 centimeters from the projection surface PP, the image interaction system 100 enters touch mode and displays detailed appliance information and the control interface, enabling, for example, turning lights on or off, adjusting the air‑conditioning temperature, or activating the sound system, thereby facilitating precise management of household appliance.

In this way, users may adjust the projection depth to go from an overview of the entire house floor plan to a specific room, and finally perform precise touch operations on individual home appliances, achieving intuitive and efficient smart home management.

In summary, in the image interaction system and image interaction method of the disclosure, by detecting the variation of depth information between the projection device and the projection surface, not only may the image content of the projected image be dynamically changed, but the corresponding operation mode may also be switched synchronously. Specifically, the embodiments of the disclosure establish a direct correlation between projection depth and the broad scale and microscopic levels of image content through hierarchical node parameters. At the same time, the projection depth is matched with the magnitude of the operation gestures of the user (e.g., large magnitude waving or small magnitude clicking), a dynamic switching mechanism for execution permission is established. Therefore, the embodiments of the disclosure effectively solve the problem of inconsistency between visual presentation and operation method in the prior art, and provide a highly integrated, intuitive and smooth immersive interactive experience, thereby greatly improving the convenience and efficiency of human-computer interaction.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An image interaction system, comprising:
a projector, configured to project an image onto a projection surface;
a depth sensor, configured to detect depth information of the projection surface; and
a processor, coupled to the projector and the depth sensor, and configured to:
change an image content of the image according to a variation of the depth information.

2. The image interaction system according to claim 1, wherein the processor is further configured to:
change the image content of the image from a distant view content to a close view content when the variation of the depth information is a depth value transitioning from large to small; and
change the image content of the image from the close view content to the distant view content when the variation of the depth information is the depth value transitioning from small to large.

3. The image interaction system according to claim 2, wherein the close view content and the distant view content are in a hierarchical scaling relationship,
when the depth value of the depth information is within a first depth interval, first multimedia data corresponding to the first depth interval is obtained from a multimedia database according to a first node parameter, and an image in the first multimedia data is used as the image;
when the depth value of the depth information is within a second depth interval, second multimedia data corresponding to the second depth interval is obtained from the multimedia database according to a second node parameter, and an image in the second multimedia data is used as the image, wherein the second node parameter is hierarchically lower than the first node parameter, the second node parameter comprises a portion of content of the first node parameter, the image of the second multimedia data is the close view content relative to the first multimedia data, and the image of the first multimedia data is a distant view content relative to the second multimedia data; and
when the depth value of the depth information is within a third depth interval, third multimedia data corresponding to the third depth interval is obtained from the multimedia database according to a third node parameter, and an image in the third multimedia data is used as the image, wherein the third node parameter is hierarchically lower than the second node parameter, the third node parameter comprises a portion of content of the second node parameter, the image of the third multimedia data is the close view content relative to the first multimedia data and the second multimedia data, and the images of the first multimedia data and the second multimedia data are the distance view contents relative to the third multimedia data.

4. The image interaction system according to claim 1, further comprising:
an image capturing device, coupled to the processor, and configured to capture a user operation image, wherein the processor is further configured to:
identify an operation object and an operation parameter of the operation object in the user operation image;
determine an execution permission of the operation parameter according to the depth information; and
execute an operation corresponding to the operation parameter according to the execution permission, wherein the execution permission determines whether the operation corresponding to the operation parameter is allowed.

5. The image interaction system according to claim 4, wherein the processor is further configured to:
when the depth value of the depth information is within a first depth interval or a second depth interval, an operation corresponding to the operation parameter corresponding to larger magnitude is allowed, and an operation corresponding to the operation parameter corresponding to smaller magnitude is not allowed; and
when the depth value of the depth information is within a third depth interval, the operation corresponding to the operation parameter corresponding to larger magnitude is not allowed, and the operation corresponding to the operation parameter corresponding to smaller magnitude is allowed.

6. An image interaction method, comprising:
projecting an image onto a projection surface through a projector;
detecting depth information corresponding to the projection surface through a depth sensor; and
changing an image content of the image according to a variation of the depth information through a processor.

7. The image interaction method according to claim 6, wherein changing the image content of the image according to the variation of the depth information comprises:
changing the image content of the image from a distant view content to a close view content when the variation of the depth information is a depth value transitioning from large to small; and
changing the image content of the image from the close view content to the distant view content when the variation of the depth information is the depth value transitioning from small to large.

8. The image interaction method according to claim 7, wherein the close view content and the distant view content are in a hierarchical scaling relationship, and changing the image content of the image according to the variation of the depth information comprises:
when the depth value of the depth information is within a first depth interval, obtaining first multimedia data corresponding to the first depth interval from a multimedia database according to a first node parameter, and using an image in the first multimedia data as the image;
when the depth value of the depth information is within a second depth interval, obtaining second multimedia data corresponding to the second depth interval from the multimedia database according to a second node parameter, and using an image in the second multimedia data as the image, wherein the second node parameter is hierarchically lower than the first node parameter, the second node parameter comprises a portion of content of the first node parameter, the image of the second multimedia data is the close view content relative to the first multimedia data, and the image of the first multimedia data is a distant view content relative to the second multimedia data; and
when the depth value of the depth information is within a third depth interval, obtaining third multimedia data corresponding to the third depth interval from the multimedia database according to a third node parameter, and using an image in the third multimedia data as the image, wherein the third node parameter is hierarchically lower than the second node parameter, the third node parameter comprises a portion of content of the second node parameter, the image of the third multimedia data is the close view content relative to the first multimedia data and the second multimedia data, and the images of the first multimedia data and the second multimedia data are the distance view contents relative to the third multimedia data.

9. The image interaction method according to claim 6, further comprising:
capturing a user operation image through an image capturing device;
identifying an operation object and an operation parameter of the operation object in the user operation image through the processor;
determining an execution permission of the operation parameter according to the depth information through the processor; and
executing an operation corresponding to the operation parameter according to the execution permission through the processor, wherein the execution permission determines whether the operation corresponding to the operation parameter is allowed.

10. The image interaction method according to claim 9, wherein determining the execution permission of the operation parameter according to the depth information comprises:
when the depth value of the depth information is within a first depth interval or a second depth interval, allowing an operation corresponding to the operation parameter corresponding to larger magnitude, and not allowing an operation corresponding to the operation parameter corresponding to smaller magnitude; and
when the depth value of the depth information is within a third depth interval, not allowing the operation corresponding to the operation parameter corresponding to larger magnitude, and allowing the operation corresponding to the operation parameter corresponding to smaller magnitude.
